(19) United States
(12) Patent Application Publication
(10) Pub. No.: US 2010/0176877 A1
(43) Pub. Date: Jul. 15, 2010

(54) DIRECT-CURRENT POTENTIAL GENERATION CIRCUIT, MULTISTAGE CIRCUIT AND COMMUNICATION APPARATUS

(75) Inventors: Mariko SUGAWARA, Kawasaki (JP); Yukito TSUNODA, Kawasaki (JP); Satoshi IDE, Kawasaki (JP)

Correspondence Address: Fujitsu Patent Center;Fujitsu Management Services of America, Inc., 2318 Mill Road, Suite 1010, Alexandria, VA, 22314, US

(73) Assignee: FUJITSU LIMITED, Kawasaki (JP)

(21) Appl. No.: 12/620,980

(22) Filed: Nov. 18, 2009

(30) Foreign Application Priority Data
Jan. 15, 2009 (JP) 2009-006200

(51) Int. Cl. G05F 3/02

(52) U.S. Cl. 327/538

(57) ABSTRACT

A current source generates a direct-current potential at a terminal of a resistor by supplying a current to the resistor and a diode-connected transistor coupled to the resistor in series.

### CROSS-REFERENCE TO RELATED APPLICATIONS

This application is based upon and claims the benefit of priority of the prior Japanese Patent Application No. 2009-006200, filed on Jan. 15, 2009, the entire contents of which are incorporated herein by reference.

### FIELD

The embodiments discussed herein relate to a direct-current potential generation circuit, a multistage circuit including a direct-current potential generation circuit, and a communication apparatus including a multistage circuit.

### BACKGROUND

In recent years, the speed and capacity of communication networks has kept increasing, and in such communication networks, amplification and waveform shaping of high-speed electric signals are performed. In addition, in a circuit used for a communication apparatus such as a transmitter, receiver, relay apparatus and so on, the reduction of power consumption has been an urgent task, so it can be said that the circuit design is facing strict requirements.

In order to perform the amplification and waveform shaping of high-speed electric signals, a multistage configuration is often adopted for the configuration of an amplifier circuit and waveform shaping circuit. In a multistage circuit, in order to realize the low-power consumption and to establish direct-current potential designing of a next-stage circuit, there are some cases in which it is preferable to design a previous-stage circuit with a low output direct-current potential.

FIG. 1 illustrates a configuration example of a two-stage differential amplifier circuit that is an example of a multistage circuit. The two-stage differential amplifier circuit in FIG. 1 has input terminals 101-1, 101-2, resistors 102, 103-1, 103-2, 106-1, 106-2, and transistors 104-1, 104-2, 107-1, 107-2, 108-1, 108-2. The two-stage differential amplifier circuit in FIG. 1 further has current sources 105, 109, and output terminals 110-1, 110-2.

The transistors 104-1 and 104-2 are differential transistors of the first stage, and the transistors 107-1,107-2, 108-1, 108-2 are differential transistors of the second stage.

The resistors 102, 103-1, 103-2, transistors 104-1, 104-2 and the current source 105 constitute a differential amplifier of the first stage. One terminal of the resistor 102 is coupled to a power supply potential VDD, and a resistor 103-j (j=1, 2) is coupled to the other terminal. The resistor 103-j is coupled to the drain of the transistor 104-j, and the current source 105 is coupled to the source of the transistor 104-j and the ground potential.

The resistors 106-1, 106-2, transistors 107-1, 107-2, 108-1, 108-2 and the current source 109 constitute the differential amplifier of the second stage. One terminal of the resistor 106-j is coupled to a power supply potential VDD, the other terminal is coupled to the drain of the transistor 107-j. The source of the transistor 107 is coupled to the drain of the transistor 108-j, and the current source 109 is coupled to the source of the transistor 108 and the ground potential.

The input terminal 101-j is coupled to the gate of the transistor 104-j of the first stage, and the drain of the transistor 104-j is coupled to the gate of the transistor 108-j of the second stage. The drain of the transistor 107-j of the second stage is coupled to the output terminal 110-j.

The differential amplifier of the first stage amplifies the difference in potential of signals supplied to the input terminals 101-1 and 101-2, and outputs it to the gates of the transistors 108-1 and 108-2. The second differential amplifier amplifies the difference in potential of signals supplied to the gates of the transistors 108-1 and 108-2, and outputs output signals from the output terminals 110-1 and 110-2.

In the differential amplifier of the second stage, the transistor 107-j and the transistor 108-j are coupled by cascode connection. By using the cascode connection, the influence of the capacitance of the transistor 108-j is avoided, and a good high-frequency characteristic can be obtained even in the case of amplifying a high-speed electric signal.

However, due to the insertion of the cascode connection, the potential at the drain (point C) of the transistor 108-2 becomes lower than the potential at the output terminal 110-2. In order to secure the drain voltage required for the operation of the transistor 108-2 in this state, the power supply potential VDD needs to be set higher, or the potential at the source (point B) of the transistor 108-2 needs to be set lower. However, since the power supply potential VDD is set lower to realize the low-power consumption, it is preferable to design the point B with a lower potential.

The potential at the point B takes a value corresponding to the potential at the gate of the transistor 108-2 (point A) with a voltage drop of a threshold voltage Vth that is a gate voltage required to let a current flow between the drain and the source. Therefore, it follows that the potential at the point B can be decreased by decreasing the potential of the point A.

In a conventional two-stage differential amplifier circuit, the insertion of the resistor 102 between the power supply potential VDD and the resistor 103-j is used as a method to decrease the potential at the point A. The direct-current potential at the point A can be calculated from the power supply potential VDD, the resistance value R, of the resistor 102, the resistance value R, of the resistor 103-j, and the current value I_{ref} of the current source. For example, assuming the VDD as 1.2V_{c} as 10Ω, Rₒ as 30Ω and I_{ref} as 20 mA, the direct-current potential at the point A is 0.7V. Further, assuming the Vth as 0.6V, the potential at the point B is 0.1V.

There has also been a known Metal Oxide Semiconductor (MOS) current supply circuit with a reduced influence of deviations in the manufacturing process of MOS transistors.

Patent document 1: Japanese Laid-open patent application 61-288607

### SUMMARY

According to an aspect of the embodiment, a direct-current potential generation circuit includes a resistor; a diode-connected transistor coupled to the resistor in series; and a current source. The current source generates a direct-current potential at a terminal of the resistor by supplying a current to the resistor and the transistor.

According to another aspect of the embodiment, a multistage circuit includes a first-stage circuit configured to output a first signal; a second-stage circuit including a first transistor and configured to output a second signal; and a direct-current potential generation circuit. The first-stage circuit outputs the first signal to the gate of the first transistor, and the direct-current potential generation circuit includes a resistor; a second transistor coupled to the resistor in series; and a current source.

The current source generates a direct-current potential at a terminal of the resistor by supplying a current to the resistor and the second transistor. The terminal of the resistor is coupled to the first-stage circuit or the gate of the first transistor. The second transistor is a diode-connected transistor.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a configuration diagram of a conventional two-stage differential amplifier circuit;

FIG. 2 is a diagram illustrating the relation between the gate voltage and the drain current of transistors;

FIG. 3 is a diagram illustrating the relation between the threshold voltage and the potential at the source of transistors;

FIG. 4 is a configuration diagram of a first two-stage differential amplifier circuit;

FIG. 5 is a diagram illustrating the comparison result of the direct-current potential in the conventional two-stage differential amplifier circuit and the first two-stage differential amplifier circuit;

FIG. 6 is a configuration diagram of a second two-stage differential amplifier circuit;

FIG. 7 is a configuration diagram of a first two-stage amplifier circuit;

FIG. 8 is a configuration diagram of a second two-stage amplifier circuit;

FIG. 9 is a configuration diagram of an optical transmission system;

FIG. 10 is a configuration diagram of a first multiplexer; and

FIG. 11 is a configuration diagram of a second multiplexer.

### DESCRIPTION OF EMBODIMENTS

The conventional two-stage differential amplifier circuit has the following problem.

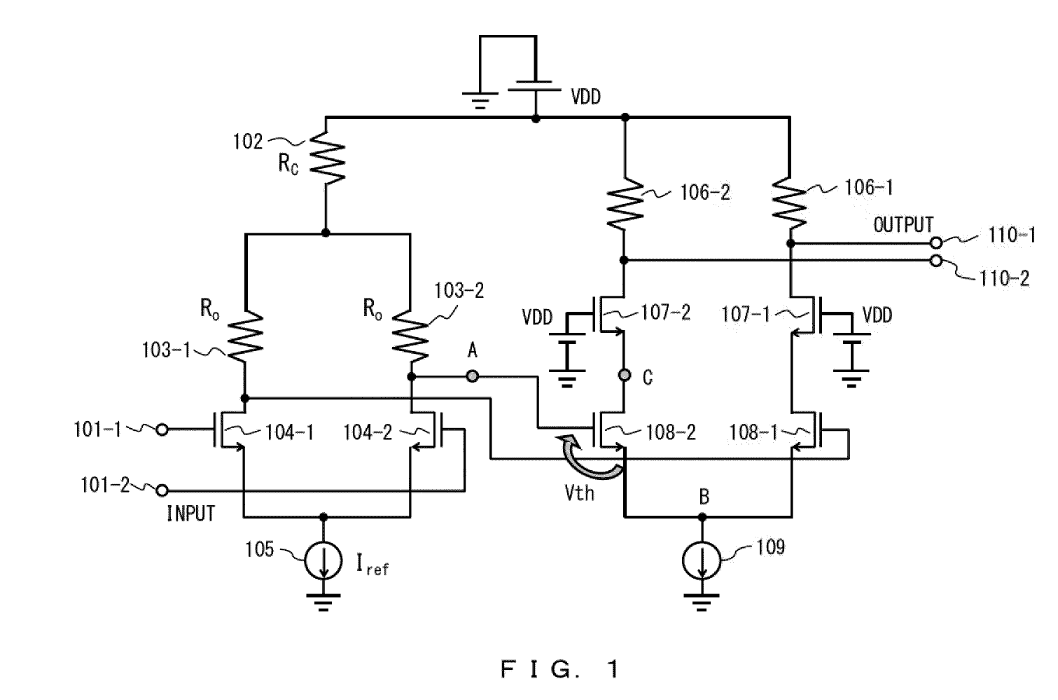

When the threshold voltage Vth of the transistor 108-2 is 0.6V and the voltage at the point B is 0.1V in FIG. 1, it is apparent that the lower-potential side of the direct current potential in the differential amplifier of the second stage does not have an enough margin. Here, if the Vth fluctuates due to the deviation in the manufacturing process (process deviation), the direct-current potential design may not be realized.

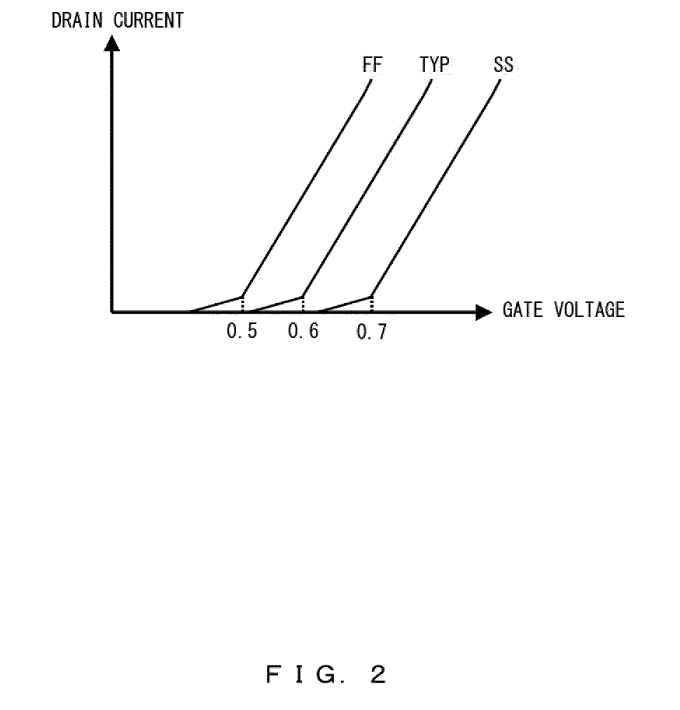

FIG. 2 illustrates the relation between the gate voltage and the drain current of transistors. TYP represents a typical transistor, SS represents a transistor with its Vth varied toward a larger value and FF represents the transistor with its Vth varied to a smaller value. Vth of the transistors TYP, SS and FF is 0.6V, 0.7V and 0.5V, respectively.

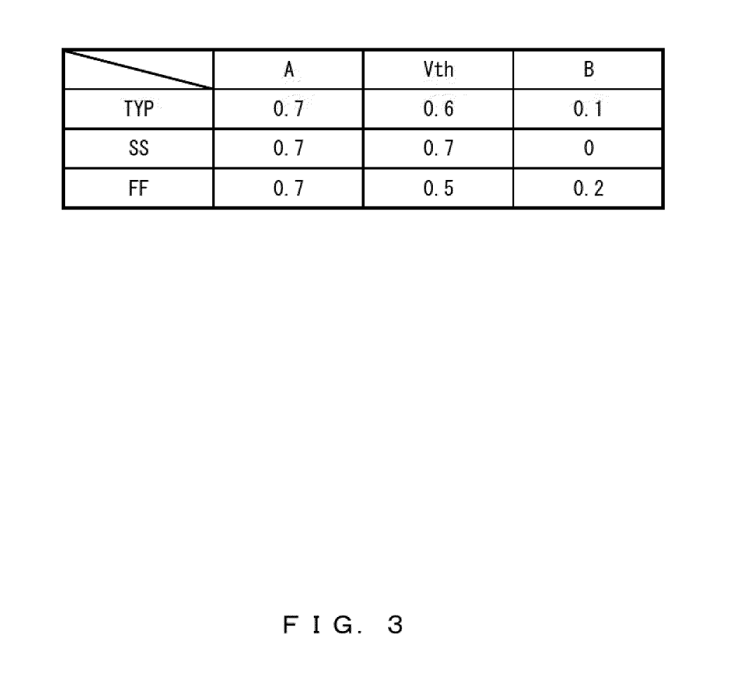

FIG. 3 illustrates the relation between Vth of the three kinds of transistors and the potential at the point B. Assuming the potential at the point A as 0.7V, when the transistor 108-2 is a TYP transistor, the potential at the point B is 0.1V. When the transistor 108-2 is a FF transistor, the potential at the point B is 0.2V, and compared to the case of TYP, there is an enough margin on the lower-potential side in the direct-current potential designing.

On the other hand, when the transistor 108-2 is an SS transistor, the potential at the point B is 0V. In this case, since the differential amplifier of the second stage does not operate properly due to the shortage of the voltage for driving the current source 109, the direct-current potential design of the second stage cannot be realized.

Not only the two-stage differential amplifier circuit but also a multistage circuit in which an output signal from a previous-stage circuit is input to the gate of a transistor of a next-stage circuit has the same problem. That is, when attempting to realize low-power consumption in a multistage circuit, the direct-current potential design of the next-stage circuit cannot be realized because of the fluctuation of the threshold voltage due to the process deviation of the transistors. The multistage circuit includes not only a two-stage circuit but also three-stage circuit or more.

Preferred embodiments of the present invention will be explained with reference to accompanying drawings.

Even in a case in which the threshold voltage has been varied due to the process deviation of the transistors used for a multistage circuit, the direct-current potential design of a next-step circuit can be realized by controlling the output direct-current potential of the previous-stage circuit so as to change in conjunction with the variation of the threshold voltage.

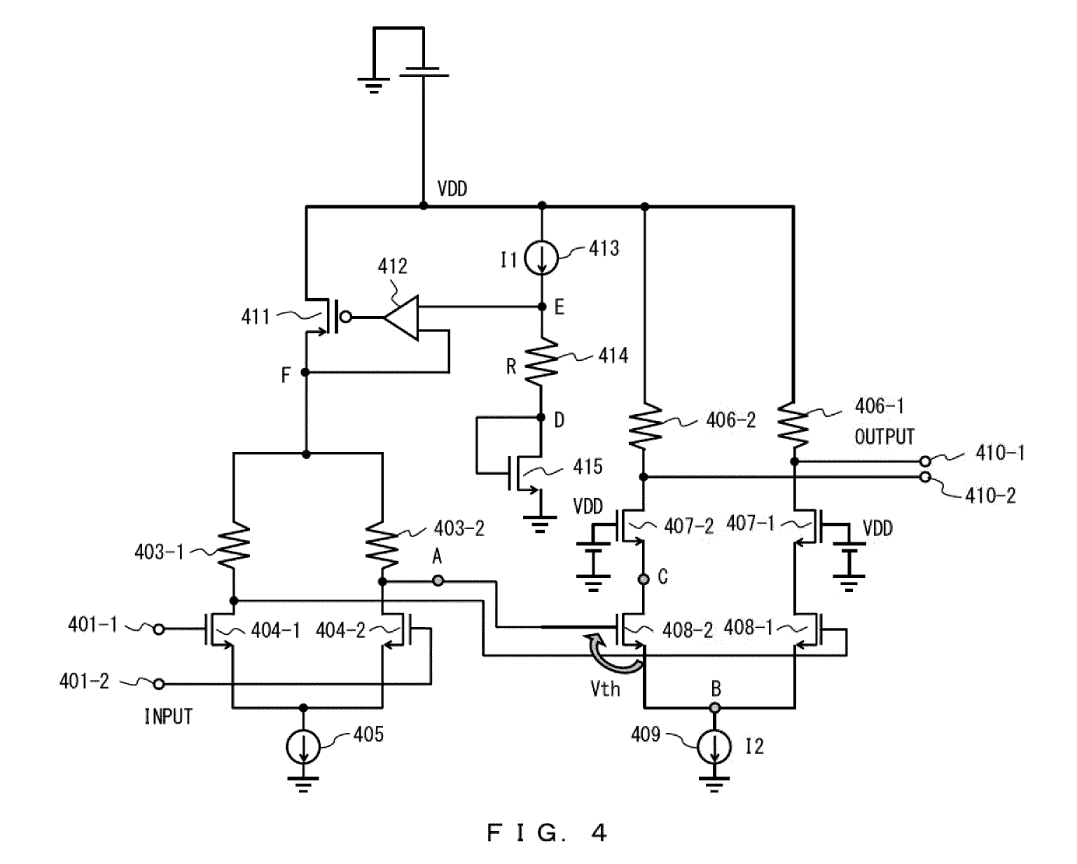

FIG. 4 illustrates a configuration example of a two-stage differential amplifier circuit that performs such direct-current potential control. The two-stage differential amplifier circuit in FIG. 4 has input terminals 401-1, 401-2, resistors 403-1, 403-2, 406-1, 406-2, 414, and transistors 404-1, 404-2, 407-1, 4072, 408-1, 408-2, 411, 415. The two-stage differential amplifier circuit further has current sources 405, 409, 413, output terminals 410-1, 410-2 and an operational amplifier 412.

The transistors 404-1, 404-2, 407-1, 407-2, 408-1, 408-2 and 415 are N-channel Metal Oxide Semiconductor Field Effect Transistor (MOSFET), and the transistor 411 is a P-channel MOSFET.

Transistors 404-1 and 404-2 are differential transistors of the first stage, and the transistors 407-1, 407-2, 408-1 and 408-2 are differential transistors of the second stage.

The resistors 403-1, 403-2, 414, transistors 404-1, 404-2, 411, 415, current sources 405, 413, and the operational amplifier 412 constitute the differential amplifier of the first stage. The source of the transistor 411 is coupled to the power supply potential VDD, and the drain of the transistor 411 is coupled to the resistor 403-j (j=1, 2). The resistor 403-j is coupled to the drain of the transistor 404-j, and the current source 405 is coupled to the source of the transistor 404-j and the ground potential.

The current source 413 is coupled to the power supply potential VDD and the resistor 414, and the resister 414 is coupled to the drain of the 415. The drain and gate of the transistor 415 is coupled (a diode-connected transistor), and the source of the transistor 415 is coupled to the ground potential. Therefore, the resistor 414 and the diode-connected transistor 415 are coupled in series.

The non-inverting input terminal of the operational amplifier 412 is coupled to the point E between the current source 413 and the resistor 414, and the inverting input terminal is coupled to the drain of the transistor 411. The output terminal of the operational amplifier 412 is coupled to the gate of the transistor 411.

The transistors 406-1, 406-2, transistors 407-1, 407-2, 408-1, 408-2, and the current source 409 constitute the differential amplifier of the second stage. One terminal of the resistor 406-j is coupled to the power supply potential VDD and the other terminal is coupled to the drain of the transistor 407-j. The source of the transistor 407-j is coupled to the drain of the transistor 408-j, and the current source 409 is coupled to the source of the transistor 408-j and the ground potential.

The output terminal 401-j is coupled to the gate of the transistor 404-j of the first stage, and the drain of the transistor 404-j is coupled to the gate of the transistor 408-j of the second stage. The drain of the transistor 407-j of the second stage is coupled to the output terminal 110-j.

The differential amplifier of the first stage amplifies the difference in potential of signals supplied to the input terminals 401-1 and 401-2, and output it to the gates of the transistors 408-1 and 408-2. The differential amplifier of the second stage amplifies the difference in potential of signals supplied to the gates of the transistors 408-1 and 408-2, and output output signals from the output terminals 410-1 and 410-2.

The two-stage differential amplifier circuit in FIG. 4 is configured with the insertion of, instead of the resistor 102 in FIG. 1, transistors 411, 415, operational amplifier 412, current source 413, and a resistor 414. The transistor 411 and the operational amplifier 412 constitute a non-inverting amplifier circuit, and the current source 413, resistor 414, and the transistor 415 constitute a direct-current potential setting circuit.

The direct-current potential setting circuit sets the direct-current potential in accordance with the threshold voltage of the transistor 415 to a point E. The potential at the drain (point D) of the transistor 415 follows the variation of the threshold voltage of the transistor 415, so the potential at the point E that is the input point to the non-inverting amplification circuit also follows the variation.

On the other hand, the non-inverting amplifier circuit outputs the input potential at the point E to the drain (point F) of the transistor 411. In the non-inverting amplifier circuit, a negative feedback loop is formed from the output terminal of the operational amplifier 412 via the transistor 411 to the inverting input terminal of the operational amplifier 412, and the point E and the point F have an approximately same potential. In other words, the potential at the point E is transferred to the point F.

Even if the power source voltage VDD varies, the gate voltage of the transistor 411 is controlled by the negative feedback operation of the operational amplifier 412, and the voltage drop by the transistor 411 is adjusted. For this reason, the state in which the point E and the point F have approximately the same potential is maintained. An N-channel MOSFET may be used instead of the transistor 411.

Since the input impedance of the operational amplifier 412 is high, little current flows to the non-inverting input terminal of the operational amplifier 412 from the point E. Therefore, the potential at the point E is determined by the current value I1 of the current source 413, the resistance value R of the resistor 414, and the potential at the point D, and the potential at the point D is determined by the threshold voltage of the transistor 415.

In integrated circuits within the same chip, the process deviation of a plurality of transistors exhibit a similar trend, so the threshold voltages of the transistors 408-j and the transistor 415 of the second stage vary in the similar way. In other words, when the threshold voltage Vth of the transistor 408-j varies toward a larger value, the threshold voltage of the transistor 415 also varies toward a larger value and when the threshold voltage Vth of the transistor 408-j varies toward a smaller value, the threshold voltage of the transistor 415 also varies toward a smaller value.

Therefore, by disposing the direct-current setting circuit and the non-inverting amplifier circuit, the potential at the point F can follow the variation of the threshold voltage Vth of the transistor 408-j. By this, the direct-current potential at the gate (point A) of the transistor 408-2 is controlled constantly to the optimal value. The direct-current voltage at the gate of the transistor 408-1 is controlled in the similar manner.

Here, by designing the direct-current setting circuit so that the current density of the transistor 415 and the current source 413 becomes the same as the current density of the transistor 408-j, the threshold voltage of the threshold value of the transistor 408-j and the transistor 415 may take the same value.

Since the drain current of the transistor 415 corresponds to the current value I1, assuming the gate width of the transistor 415 as w1, the drain current density of the transistor 415 is I1/w1.

Meanwhile, since the drain current of the transistor 408-j is half of a current value I2 of the current source 413, assuming the gate width of the transistor 408-j as w2, the drain current density of the transistor 408-j is I2/ (2w2). Therefore, it is desirable to design the direct-current potential setting circuit so as to realize I1/w1=I2/(2w2).

For example, when the current value I1 of the current source 413 is set to I2/2, the threshold voltage of the transistor 415 and the transistor 408-j becomes the same by setting the gate width w1 of the transistor 415 to the same value as w2.

Practically, the current density of the transistor 415 and the current source 413 and the current density of the transistor 408-j maybe substantially equal within a tolerance. The tolerance is, for example, set by a condition that the difference between the two current densities is within x% of either of the current densities. As x%, for example the value of about 1% to 20% may be used. By this, the threshold voltage of the transistor 408-j and that of the transistor 415 become substantially equal, making the control of the direct-current potential easy.

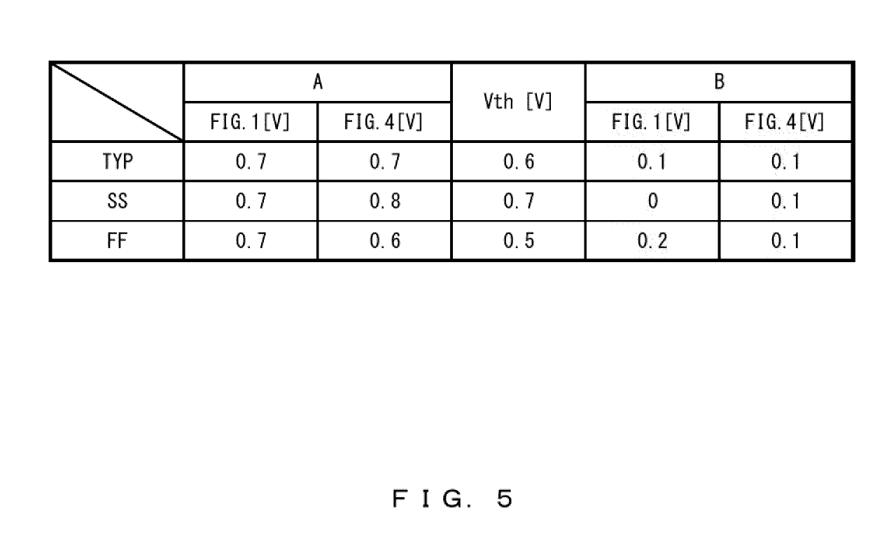

FIG. 5 illustrates the comparison result of the direct-current potential at the point A and the point B in the two-stage differential amplifier circuit in FIG. 1 and FIG. 4. Vth represents the threshold voltage of the transistor 108-2 and 408-2. The Vth of TYP, SS, and FF is 0.6V, 0.7V, and 0.5V, respectively. Other numerical values used for the comparison are as follows.

Power supply potential VDD: 1.2V

Resistance value of the resistor 102: 10Ω

Resistance value of the resistors 103-j and 403-j: 30Ω

Current value of the current sources 105 and 405: 20 mA

When the transistors 108-2 and 408-2 are TYP transistors, the potential at the point A in FIG. 1 and FIG. 4 is 0.7V, and the potential at the point B is 0.1V. Therefore, the current sources 109 and 409 both operate normally.

When the transistors 108-2 and 408-2 are SS transistors, the potential at the point A in FIG. 1 and FIG. 4 is 0.7V and 0.8V, respectively, and the potential at the point B in FIG. 1 and FIG. 4 is 0V and 0.1V, respectively. Therefore, it can be understood that the current source 109 in FIG. 1 does not operate normally, while the current source 409 in FIG. 4 operates normally.

When the transistors 108-2 and 408-2 are FF transistors, the potential at the point A in FIG. 1 and FIG. 4 is 0.7V and 0.6V, respectively, and the potential at the point B in FIG. 1 and FIG. 4 is 0.2V and 0.1V, respectively. Therefore, the current sources 109 and 409 both operate normally.

Thus, according to the configuration in FIG. 4, even in a case in which the threshold voltage of the input transistor of the differential amplifier of the second stage varies toward a larger value, the output direct-current potential of the differential amplifier of the first stage at the point A is controlled appropriately, and the differential amplifier of the second stage can operate normally. By this, it becomes possible to supply the optimal input direct-current potential with which the direct-current potential design of a next stage is realized constantly, and good amplification characteristics and waveform characteristics can be obtained.

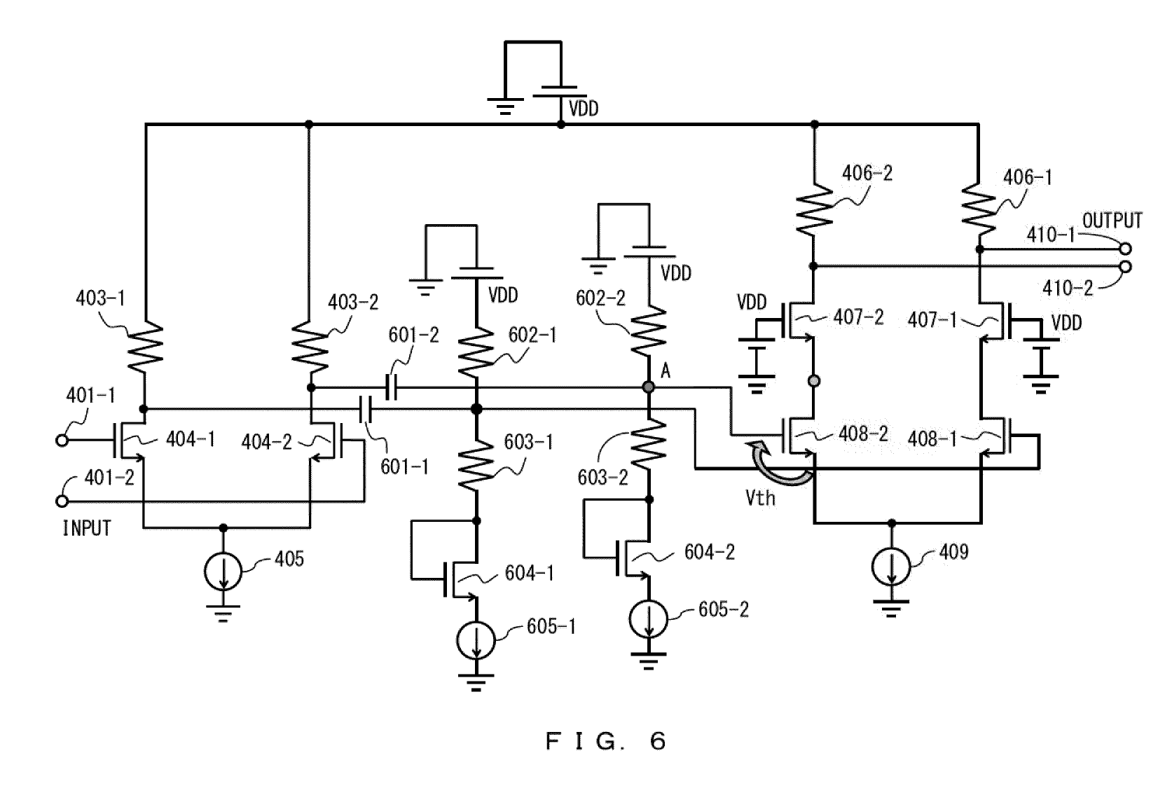

FIG. 6 illustrates another configuration example of the two-stage differential amplifier circuit. The two-stage differential amplifier circuit in FIG. 6 has a configuration in which the direct-current potential setting circuit and the non-inverting amplifier circuit are excluded from the two-stage differential amplifier circuit in FIG. 4. Instead, capacitors 601-1, 601-2, resistors 602-1, 602-2, 603-1, 603-2, transistors 604-1, 604-2, and current sources 605-1, 605-2 are disposed.

The resistors 602-j, 603-j, the transistor 604-j and the current source 605-j (j=1, 2) constitute a direct-current potential setting circuit setting the direct-current potential of the gate of the transistor 408-j.

One terminal of the transistor 602-j is coupled to the power supply potential VDD, and another terminal is coupled to the resistor 603-j and the gate of transistor 408-j, respectively. The resistor 603-j is coupled to the drain of the transistor 604-j. The drain and gate of the transistor 604-j are coupled (a diode-connected transistor), and the current source 605-j is coupled to the source of the transistor 604-j and the ground potential. Therefore, the resistor 602-j, 603-j, and the diode-connected transistor 604-j are coupled in series.

The drain of the transistor 404-j is coupled to the gate of the transistor 408-j through the capacitor 601-j.

The direct-current potential setting circuit sets a direct-current potential in accordance with the threshold voltage of the transistor 604-j to the gate of the transistor 408-j. For example, the potential at the drain (point D) of the transistor 604-2 follows the variation of the threshold voltage of the transistor 604-2, so the potential at the gate (point A) of the transistor 408-2 follows the variation.

At this time, the direct current is cut by the capacitor 601-2, the direct current does not flow from the direct-current potential setting circuit to the differential amplifier of the first stage. Therefore, the potential at the point A can be obtained through resistive division of the difference between the power supply potential VDD and the potential at the point D with resistors 602-2 and 603-2, and the potential at the point D is determined by the threshold voltage of transistor 604-2. The resistance value of the resistor 602-2 and that of the resistor 603-2 may be different or may be the same value.

As described above, since in integrated circuits within the same chip, a plurality of transistors exhibit the process deviation in a similar trend, the threshold voltage of the transistor 408-2 of the second stage and that of the transistor 604-2 vary in a similar way. Therefore, by disposing the direct-current potential setting circuit, the potential at the point A can follow the variation of the threshold voltage Vth of the transistor 408-2. In the same manner, the direct-current potential at the gate of the transistor 408-1 can follow the variation of the threshold voltage Vth of the transistor 408-1.

Here, by making the threshold voltage of the transistor 408-j and that of the transistor 604-j substantially equal, the control of the direct-current potential becomes easier. To do so, the direct-current potential setting circuit is to be designed so as to make the current density of the transistor 604-j and that of the current source 605-j substantially equal to the current density of the transistor 408-j within a tolerance.

According to the configuration of FIG. 6, in the similar manner as in the configuration in FIG. 4, even in a case in which input transistors of the differential amplifier of the second stage have process deviation, the output direct-current potential of the differential amplifier of the first stage is controlled appropriately, and the differential amplifier of the second stage can be operated normally.

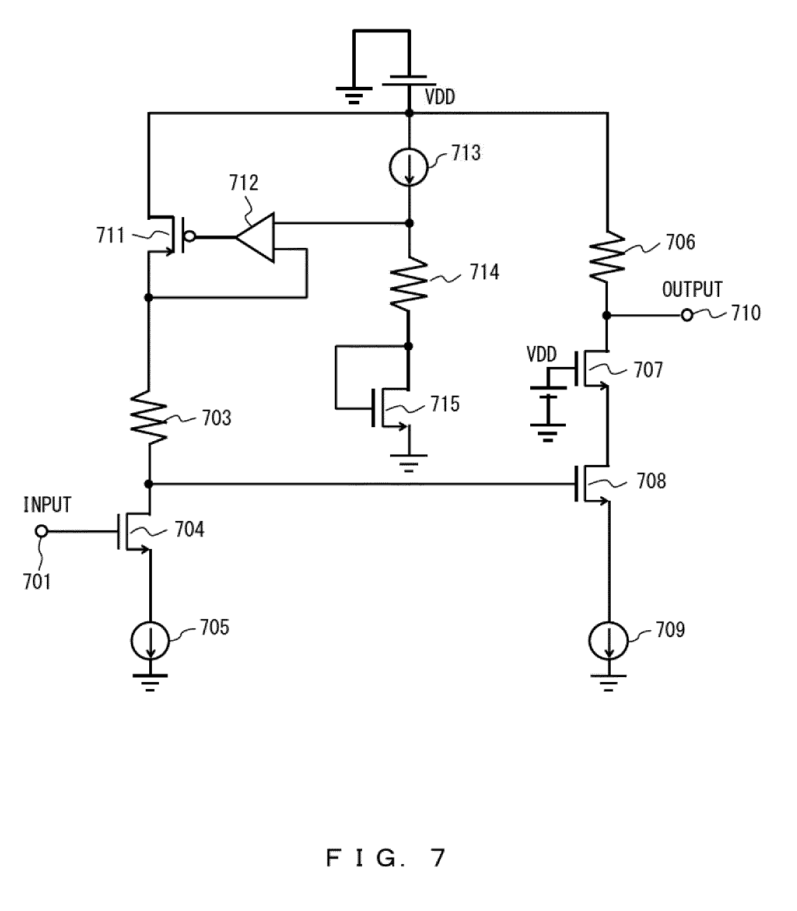

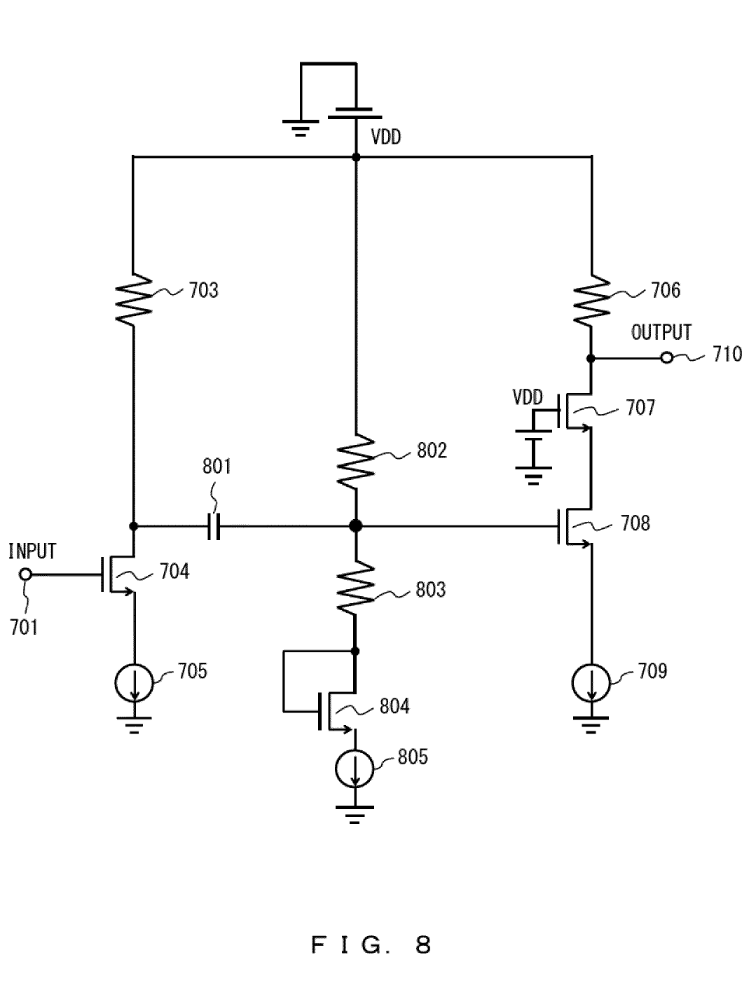

While a configuration of a two-stage differential amplifier circuit is illustrated in FIG. 4 and FIG. 6, similar direct-current potential control is possible for a single-ended two-stage amplifier circuit. Then, the configuration and operation of a single-ended two-stage amplifier circuit is explained with reference to FIG. 7 and FIG. 8.

FIG. 7 illustrates a configuration example of such a two-stage amplifier circuit. The two-stage amplifier circuit in FIG. 7 has an input terminal 701, resistors 703, 706, 714 and transistors 704, 707, 708, 711, 715, current sources 705, 909, 713, output terminal 710, and an operational amplifier 712.

The transistors 704, 707, 708 and 715 are N-channel MOSFETs, and the transistor 711 is a P-channel MOSFET.

The resistors 703, 714, transistors 704, 711, 715, current sources 705, 713 and the operational amplifier 712 constitute an amplifier of the first stage. The source of the transistor 711 is coupled to the power supply potential VDD, and the drain of the transistor 711 is coupled to the resistor 703. The resistor 703 is coupled to the drain of the transistor 704, and the current source 705 is coupled to the source of the transistor 704 and the ground potential.

The current source 714 is coupled to the power supply potential VDD and the resistor 714, and the resistor 714 is coupled to the drain of the transistor 715. The drain and gate of the transistor 715 are coupled (a diode-connected transistor), and the source of the transistor 715 is coupled to the ground potential.

The non-inverting input terminal of the operational amplifier 712 is coupled to the point between the current source 713 and the resistor 714, and the inverting input terminal is coupled to the drain of the transistor 711. The output terminal of the operational amplifier 712 is coupled to the gate of the transistor 711.

The resistor 706, transistors 707, 708 and the current source 709 constitute an amplifier of the second stage. One terminal of the resistor 706 is coupled to the power supply potential VDD, and the other terminal is coupled to the drain of the transistor 708, and the current source 709 is coupled to the part between the source of the transistor 708 and the ground potential.

The input terminal 701 is coupled to the gate of the transistor 704 of the first stage, and the drain of the transistor 704 is coupled to the gate of the transistor 707 of the second stage. The drain of the transistor 707 of the second stage is coupled to the output terminal 710.

The amplifier of the first stage amplifies a signal supplied to the input terminal 701, and outputs it to the gate of the transistor 708. The amplifier of the second stage amplifies a signal supplied to the gate of the transistor 708, and outputs an output signal from the output terminal 710.

The transistor 711 and the operational amplifier 712 constitute a non-inverting amplifier circuit, and the current source 713, resistor 714 and transistor 715 constitute a direct-current potential setting circuit. The direct-current potential setting circuit sets a direct-current potential in accordance with the threshold voltage of the transistor 715 to the non-inverting input terminal of the operational amplifier 712. The non-inverting simplifier circuit outputs the input potential of the non-inverting input terminal to the drain of the transistor 711. An N-channel MOSFET may be used instead of the transistor 711.

By disposing the direct-current setting circuit and the non-inverting amplifier circuit, the potential at the drain of the transistor 711 can follow the variation of the threshold voltage Vth of the transistor 708. Here, by making the threshold voltage of the transistor 708 and that of the transistor 715 substantially equal, the control of the direct-current potential becomes easier. To do so, the direct-current potential setting circuit is to be designed so as to make the current density of the transistor 715 and that of the current source 713 substantially equal to the current density of the transistor 708 within a tolerance.

According to the configuration of FIG. 7, in the similar manner as in the configuration in FIG. 4, even in a case in which an input transistor of the amplifier of the second stage has process deviation, the output direct-current potential of the amplifier of the first stage is controlled appropriately, and the amplifier of the second stage can be operated normally.

FIG. 8 illustrates another configuration example of the two-stage amplifier circuit. The two-stage amplifier in FIG. 8 has a configuration in which the direct-current potential setting circuit and the non-inverting amplifier circuit are excluded from the two-stage amplifier circuit in FIG. 7. Instead, capacitor 801, resistors 802, 803, transistor 804, and current source 805 are disposed.

The resistor 802, transistor 804, and current source 805 constitute a direct-current potential setting circuit that sets the direct-current potential of the gate of the transistor 708.

One terminal of the resistor 802 is coupled to the power supply potential VDD, and the other terminal is coupled to the resistor 803 and the gate of the transistor 708. The resistor 803 is coupled to the drain of the transistor 804. The drain and gate of the transistor 804 are coupled (a diode-connected transistor), and the current source 805 is coupled to the source of the transistor 804 and the ground potential.

The drain of the transistor 704 is coupled to the gate of the transistor 708 through the capacitor 801.

The direct-current potential setting circuit sets a direct-current potential in accordance with the threshold voltage of the transistor 804 to the gate of the transistor 708. Since the potential at the drain of the transistor 804 follows the variation of the threshold voltage of the transistor 804, the potential at the gate of the transistor 708 also follows the variation. Here, by making the threshold voltage of the transistor 708 and that of the transistor 804 substantially equal, the control of the direct-current potential becomes easier. To do so, the direct-current potential setting circuit is to be designed so as to make the current density of the transistor 804 and that of the current source 805 substantially equal to the current density of the transistor 708 within a tolerance.

According to the configuration of FIG. 8, in the similar manner as in the configuration in FIG. 7, even in a case in which an input transistor of the amplifier of the second stage has process deviation, the output direct-current potential of the amplifier of the first stage is controlled appropriately, and the amplifier of the second stage can be operated normally.

The configuration of an amplifier circuit illustrated in FIG. 4 and FIGS. 6-8 can be extended to multistage amplifier circuits having three or more stages. By this, even in a case in which input transistors of an amplifier of the second stage or a later stage have process deviation, the output direct-current potential of the amplifier of the preceding stage is controlled appropriately, and the amplifier of a next stage can be operated normally.

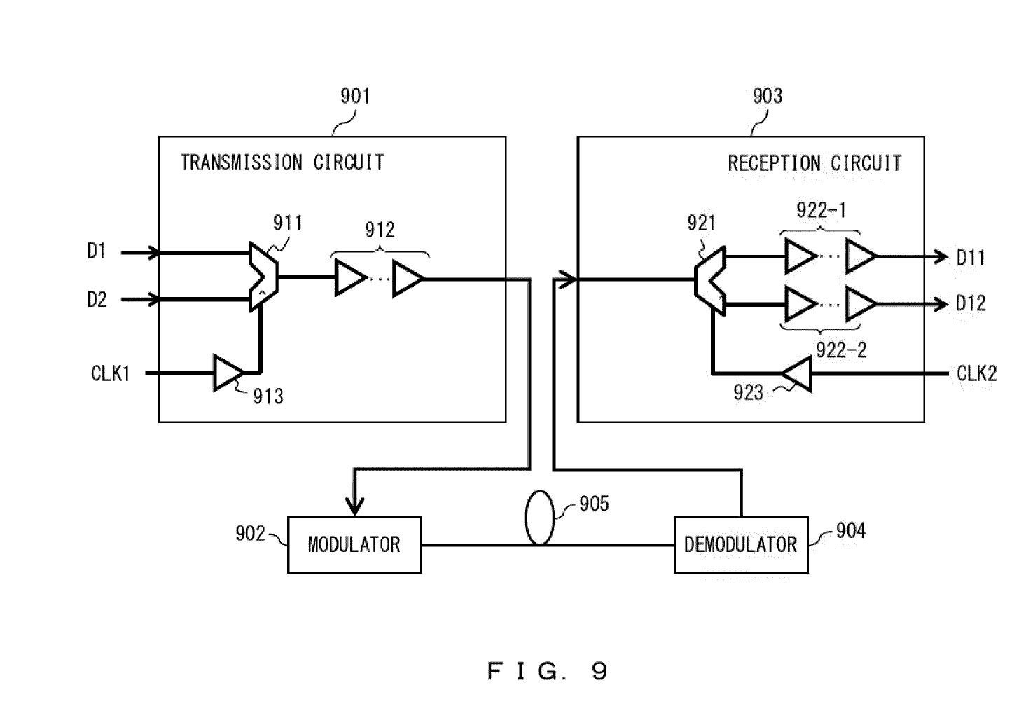

FIG. 9 illustrates a configuration example of an optical transmission system in which a multistage amplifier circuit is used for the optical transmitter and the optical receiver. The optical transmission system in FIG. 9 has a transmission circuit 901, modulator 902, reception circuit 903, demodulator 904, and optical transmission path 905. The transmission circuit 901 and the modulator 902 constitute the optical transmitter, and the reception circuit 903 and the demodulator 904 constitute the optical receiver.

The transmission circuit 901 includes multiplexer 911, multistage amplifier circuit 912 and buffer 913, and the reception circuit 903 includes a demultiplexer 921, multistage amplifier circuits 922-1, 922-2 and buffer 923.

In the transmission circuit 901, a clock signal CLK1 is input to the multiplexer 911 through the buffer 913. The multiplexer 911 multiplexes low-speed data signals D1 and D2 in synchronization with the clock signal CLK1, to generate a high-speed data signal. The multistage amplifier circuit 912 amplifies the high-speed data signal and outputs it to the modulator 902 as a transmission signal.

The modulator 902 modulates a signal light output from a signal light source (not illustrated in the drawings) with the transmission signal output from the transmission circuit to generate an optical signal, and outputs it to the optical transmission path 905.

The demodulator 904 demodulates the optical signal input from the optical transmission path 905 by mixing the optical signal with a local light output from a local light source (not illustrated in the drawings), and generates a high-speed data signal through a photoelectric conversion.

In the reception circuit 903, a clock signal CLK2 is input to the demultiplexer 921 through the buffer 923. The demultiplexor 921 generates two low-speed data signals by demultiplexing the high-speed data signal in synchronization with the clock signal CLK2. The multistage amplifier circuits 922-1 and 922-2 amplify the respective low-speed data signals, and output them as low-speed data signals D11 and D12.

In this case, by using the multistage amplifier circuit in the embodiments as the multistage amplifier circuits 912, 922-1 and 922-2, even when the transistors have process deviation, the multistage amplifier circuits 912, 922-1 and 922-2 can be operated normally.

Meanwhile, while the number of the low-speed data signals before and after the multiplexing is two in the configuration of FIG. 9, the communication may be conducted while multiplexing three or more low-speed data signals.

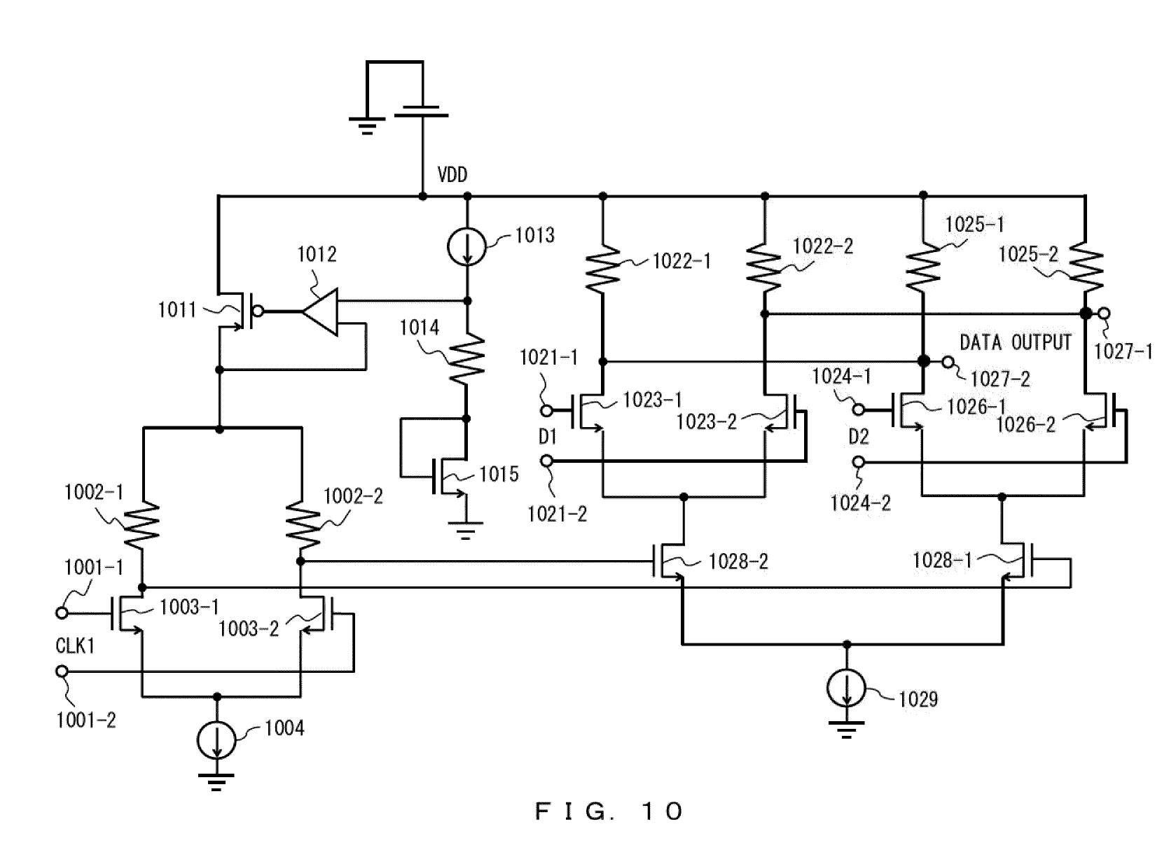

Meanwhile, the configuration of the embodiment is not limited to an amplifier circuit, and may be used for various multistage circuits having circuits in two or more stages. For example, when the configuration in FIG. 4 is applied to the multiplexer 911 in FIG. 9, the circuit configuration is as illustrated in FIG. 10.

The multiplexer in FIG. 10 has input terminals 1001-1, 1001-2, 1021-1, 1021-2, 1024-1, 1024-2, and resistors 1002-1, 1002-2, 1014, 1022-1, 1022-2, 1025-1, 1025-2. The multiplexer in FIG. 10 further has transistors 1003-1, 1003-2, 1011, 1015, 1023-1, 1023-2, 1026-1, 1026-2, 1028-1, 1028-2. The multiplexer in FIG. 10 further has current sources 1004, 1013, 1029, output terminals 1027-1, 1027-2, and operational amplifier 1012.

The transistors 1003-1, 1003-2, 1011, 1015, 1023-1, 1023-2, 1026-1, 1026-2, 1028-1, 1028-2 are N-channel MOSFETs, and the transistor 1011 is a P-channel MOSFET.

The transistor 1003-1 and the 1003-2 are the differential transistors of the first stage, and the 1023-1, 1023-2, 1026-1, 1026-2, 1028-1, 1028-2 are the differential transistors of the second stage.

The resistor 1002-1, 1002-2, 1014, transistors 1003-1, 1003-2, 1011, 1015, current sources 1004, 1013, and operational amplifier 1012 constitute the circuit of the first stage. The source of the transistor 1011 is coupled to the power supply potential VDD, and the drain of the transistor 1011 is coupled to the resistor 1002-j (j=1, 2). The resistor 1002-j is coupled to the drain of the transistor 1003-j, and the current source 1004 is coupled to the source of the transistor 1003-j and the ground potential.

The current source 1013 is coupled to the power supply potential VDD and the resistor 1014, and the resistor 1014 is coupled to the drain of the transistor 1015. The drain and gate of the transistor 105 are coupled (a diode-connected transistor), and the source of the transistor 1015 is coupled to the ground potential.

The non-inverting input terminal of the operational amplifier 1012 is coupled to the point between the current source 1013 and the resistor 1014, and the inverting input terminal is coupled to the drain of the transistor 1011. The output terminal of the operational amplifier 1012 is coupled to the gate of the transistor 1011.

The resistors 1022-1, 1022-2, 1025-1, 1025-2, transistors 1023-1, 1023-2, 1026-1, 1026-2, 1028-1, 1028-2 and the current source 1029 constitute the circuit of the second stage. One terminal of the resistor 1022-j and 1025-j is coupled to the power supply potential VDD, and the other terminal is coupled to the drain of the transistor 1023-j and 1026-j. The source of the transistors 1023-j and 1026-j is coupled to the drain of the transistors 1028-2 and 1028-1, and the current source 1029 is coupled to the source of the transistor 1028-j and the ground potential.

The input terminal 1001-j is coupled to the gate of the transistor 1003-j of the first stage, and the drain of the transistor 1003-j is coupled to the gate of the transistor 1028-j of the second stage. The drain of the transistors 1023-1 and the 1026-1 of the second stage is coupled to the output terminal 1027-2, and the drain of the transistors 1023-2 and 1026-2 is coupled to the output terminal 1027-1.

The circuit of the first stage amplifies the difference in potential of signals input to the input terminals 1001-1 and 1001-2 as the clock signal CKL1, and outputs it to the gates of the transistors 1028-1 and 1028-2.

The circuit of the second stage selects, when a low-level (L) signal and a high-level (H) signal are supplied to the input terminals 1021-1 and 1021-2 respectively, the signals input to the input terminals 1021-1 and 1021-2 as the low-speed data signal D1. Then, the selected low-speed data signal D1 is output from the output terminals 1027-1 and 1027-2.

Meanwhile, when an H signal and L signal is supplied to the transistor 1028-1 ad 1028-2 respectively, the signals input to the input terminals 1024-1 and 1024-2 as the low-speed data signal D2 is selected. Then, the selected low-speed data signal D2 is output from the output terminals 1027-1 and 1027-2.

The transistor 1011 and the operational amplifier 1012 constitute a non-inverting amplifier circuit, and the current source 1013, resistor 1014, and transistor 1015 constitute a direct-current potential setting circuit. By disposing the direct-current setting circuit and the non-inverting amplifier circuit, the potential of the drain of the transistor 1011 can follow the variation of the threshold voltage Vth of the transistor 1028-j.

Here, by making the threshold voltage of the transistor 1028-j and that of the transistor 1015 substantially equal, the control of the direct-current potential becomes easier. To do so, the direct-current potential setting circuit is to be designed so as to make the current density of the transistor 1015 and that of the current source 1013 substantially equal to the current density of the transistor 1028-j within a tolerance.

According to the configuration of FIG. 10, in the similar manner as in the configuration in FIG. 4, even in a case in which input transistors of the circuit of the second stage have process deviation, the output direct-current potential of the circuit of the first stage is controlled appropriately, and the circuit of the second stage can be operated normally.

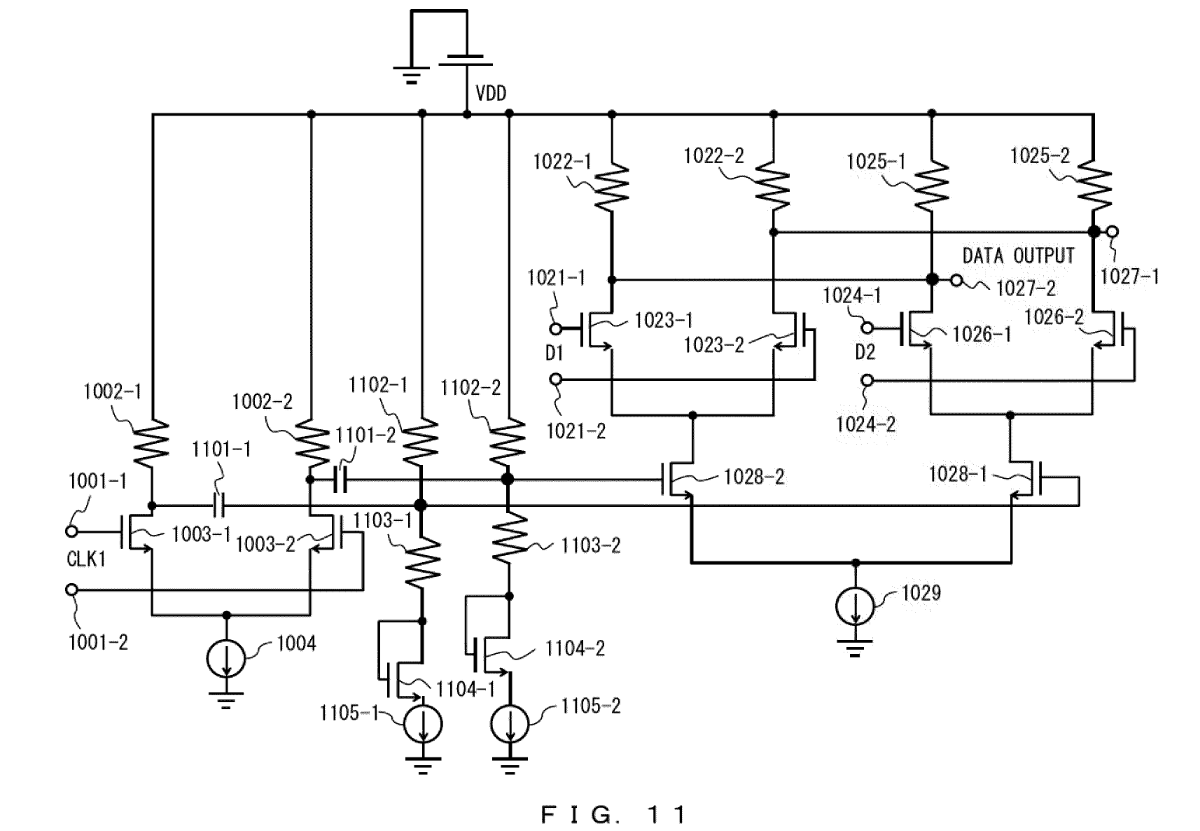

FIG. 11 illustrates an configuration example in which the configuration of FIG. 6 is applied to the multiplexer 911 in FIG. 9. The multiplexer in FIG. 11 has a configuration in which the direct-current potential setting circuit and the non-inverting amplifier circuit are excluded from the multiplexer in FIG. 10. Instead, capacitor 1101-1, 1101-2, resistors 1102-1, 1102-2, 1103-1, 1103-2, transistors 1104-1, 1104-2, and current source 1105-1, 1105-2 are disposed.

The resistor 1102-j, 1103-j, transistor 1104-j, and current source 1105-j (j=1, 2) constitute a direct-current potential setting circuit that sets the direct-current potential at the gate of the transistor 1028-j.

One terminal of the resistor 1102-j is coupled to the power supply potential VDD, and the other terminal is coupled to the resistor 1103-j and the gate of the transistor 1028-j. The resistor 1103-j is coupled to the drain of the transistor 1104-j. The drain and gate of the transistor 1104-j are coupled (a diode-connected transistor), and the current source 1105-j is coupled to the source of the transistor 1104-j and the ground potential.

The drain of the transistor 1003-j is coupled to the gate of the transistor 1028-j through the capacitor 1101-j.

The direct-current potential setting circuit sets a direct-current potential in accordance with the threshold voltage of the transistor 1104-j to the gate of the transistor 1028-j. Since the potential at the drain of the transistor 1104 follows the variation of the threshold voltage of the transistor 1104-2, the potential at the gate of the transistor 1028-j also follows the variation.

Here, by making the threshold voltage of the transistor 1028-j and that of the transistor 1104-j substantially equal, the control of the direct-current potential becomes easier. To do so, the direct-current potential setting circuit is to be designed so as to make the current density of the transistor 1104-j and that of the current source 1105-j substantially equal to the current density of the transistor 1028-j within a tolerance.

According to the configuration of FIG. 11, in the similar manner as in the configuration in FIG. 10, even in a case in which input transistors of the circuit of the second stage have process deviation, the output direct-current potential of the circuit of the first stage is controlled appropriately, and the circuit of the second stage can be operated normally.

According to the embodiments described above, even in a case in which a transistor used for a multistage circuit has process deviation, the output direct-current potential of a preceding circuit is controlled appropriately and a next-stage circuit can be operated normally.

Meanwhile, the multistage circuit in the embodiments can be used for a communication apparatus including an optical transmitter, optical receiver and a relay apparatus, and can also be used for other apparatuses of which circuit design faces strict requirements.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A direct-current potential generation circuit comprising:
a resistor;
a diode-connected transistor coupled to the resistor in series; and
a current source configured to generate a direct-current potential at a terminal of the resistor by supplying a current to the resistor and the transistor.

2. The direct-current potential generation circuit according to claim 1, further comprising:
a non-inverting amplifier circuit coupled to the terminal of the resistor and configured to output the direct-current potential generated at the terminal.

3. The direct-current potential generation circuit according to claim 1, further comprising:
a resistor coupled to the resistor in series.

4. A multistage circuit comprising:
a first-stage circuit configured to output a first signal;
a second-stage circuit including a first transistor and configured to output a second signal; and
a direct-current potential generation circuit,
wherein
the first-stage circuit outputs the first signal to agate of the first transistor,
the direct-current potential generation circuit comprises:
a resistor;
a second transistor coupled to the resistor in series; and
a current source configured to generate a direct current potential at a terminal of the resistor by supplying a current to the resistor and the second transistor, and
the terminal of the resistor is coupled to the first-stage circuit or the gate of the first transistor, and the second transistor is a diode-connected transistor.

5. The multistage circuit according to claim 4, wherein
the direct-current potential generation circuit further comprises a non-inverting amplification coupled to the terminal of the resistor and configured to output the direct-current potential generated at the terminal.

6. The multistage circuit according to claim 4, wherein
the direct-current potential generation circuit further comprises a resistor coupled to the resistor in series.

7. The multistage circuit according to claim 4, wherein
a current density of the first transistor is substantially equal to a current density of the second transistor.

8. A communication apparatus comprising:
a first-stage circuit configured to output a first signal;
a second-stage circuit including a first transistor and configured to output a second signal; and
a direct-current potential generation circuit,
wherein
the first-stage circuit outputs the first signal to agate of the first transistor,
the direct-current potential generation circuit comprises:
a resistor;
a second transistor coupled to the resistor in series; and
a current source configured to generate a direct current potential at a terminal of the resistor by supplying a current to the resistor and the second transistor, and
the terminal of the resistor is coupled to the first-stage circuit or the gate of the first transistor, and the second transistor is a diode-connected transistor.
